(19) United States
(12) Patent Application Publication
(10) Pub. No.: US 2009/0013017 A1
(43) Pub. Date: Jan. 8, 2009

(54) Methods, Systems, and Computer Program Products for Optimizing Virtual Machine Memory Consumption

(76) Inventors: Steven J. Branda, Rochester, MN (US); William T. Newport, Rochester, MN (US); John J. Stecher, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 11/773,023

(22) Filed: Jul. 3, 2007

(51) Int. Cl. G06F 12/02

(52) U.S. Cl. 707/206; 707/E17.005

(57) ABSTRACT

A method, system, and computer program product for optimizing virtual machine (VM) memory consumption are provided. The method includes monitoring VM accesses to a plurality of objects in a heap, and identifying a dead object among the objects in the heap. The method also includes copying the dead object to a data storage device as a serialized object, and replacing the dead object in the heap with a loader object. The loader object is smaller than the dead object and includes a reference to the serialized object.

### BACKGROUND OF THE INVENTION

The present disclosure relates generally to computer memory management, and, in particular, to optimizing virtual machine memory consumption.

With a heavy reliance on Java™ platform enterprise edition (JEE) middleware servers in modern information technology infrastructures, the Java™ virtual machine (JVM™) has become a lynchpin runtime for many major and minor applications. A virtual machine may allocate and manage memory dynamically as a heap. One major issue with JVMs™ is that the size of the virtual machine's heap typically dictates the best possible performance of the application, because the worst-case response time is dominated by how long garbage collection takes. This is true for both a generational garbage collection algorithm and a flat heap model. In modern application servers, numerous “dead” objects are stagnant in the heap but remain referenced. Thus, even though the dead objects are rarely, if ever, used, they cannot be removed using garbage collection to free space. For example, an admin console or part of the runtime that is only used at startup and/or shutdown, such as a configuration model or set of helper classes, may be considered dead objects. These objects are created and occupy space in the heap, causing garbage collection to occur more frequently than otherwise would be necessary, thus diminishing performance. Accordingly, there is a need in the art for optimizing virtual machine memory consumption.

### BRIEF SUMMARY OF THE INVENTION

Embodiments of the invention include a method for optimizing virtual machine (VM) memory consumption. The method includes monitoring VM accesses to a plurality of objects in a heap, and identifying a dead object among the objects in the heap. The method also includes copying the dead object to a data storage device as a serialized object, and replacing the dead object in the heap with a loader object. The loader object is smaller than the dead object and includes a reference to the serialized object.

Additional embodiments include a system for optimizing VM memory consumption. The system includes a host system in communication with a data storage device. The host system executes a VM. The VM monitors accesses to a plurality of objects in a heap and identifies a dead object among the objects in the heap. The VM also copies the dead object to the data storage device as a serialized object, and replaces the dead object in the heap with a loader object. The loader object is smaller than the dead object and includes a reference to the serialized object.

Further embodiments include a computer program product for optimizing VM memory consumption. The computer program product includes a storage medium readable by a processing circuit and storing instructions for execution by the processing circuit for implementing a method. The method includes monitoring VM accesses to a plurality of objects in a heap, and identifying a dead object among the objects in the heap. The method also includes copying the dead object to a data storage device as a serialized object, and replacing the dead object in the heap with a loader object. The loader object is smaller than the dead object and includes a reference to the serialized object.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a system for optimizing virtual machine memory consumption in accordance with exemplary embodiments;

FIG. 2 depicts exemplary objects in a heap prior to virtual machine memory consumption optimization;

FIG. 3 depicts exemplary objects in a heap and in a data storage device after virtual machine memory consumption optimization;

FIG. 4 depicts exemplary objects in a heap after object restoration; and

FIG. 5 depicts a process for optimizing virtual machine memory consumption in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments, as shown and described by the various figures and the accompanying text, provide methods, systems and computer program products for optimizing virtual machine memory consumption. Numerous programming languages, such as Java™, that dynamically allocate objects in a heap also employ garbage collection to dispose of objects that are no longer referenced, thus freeing space in the heap associated with the non-referenced objects. However, garbage collection does not dispose of objects that are referenced but infrequently used. Such objects are referred to herein as “dead” objects. In exemplary embodiments, dead objects are identified in the heap, and the dead objects are “deflated” to increase available space in the heap. Many programming languages, such as Java™, rely on a virtual machine to manage the use of system resources, including the heap. Through freeing up the space occupied by dead objects in the heap, virtual machine memory consumption can be optimized to increase performance for the runtime of an application. Performance improvements may be in the form reduced garbage collection frequency, as exceeding an allocated amount of memory in the heap typically triggers garbage collection. Therefore, lowering the garbage collection frequency can increase the amount of processing throughput available for application execution, as less time is consumed by processing overhead. Further improvements may include reducing heap fragmentation, as larger dead objects of varying size are replaced with smaller loader objects during the deflation process, thus freeing larger contiguous memory blocks for use.

Although dead objects are stagnant, they may not be completely eliminated, because they are still referenced and thus are not technically garbage. In exemplary embodiments, a deflated dead object is inflated (i.e., restored) when a reference to the deflated object is traversed. Thus, an infrequently accessed object that is considered dead can still be accessed upon demand, but its associated heap space may be substantially reduced through deflation until another object attempts to access the dead object. Further details of optimizing virtual machine memory consumption are provided herein.

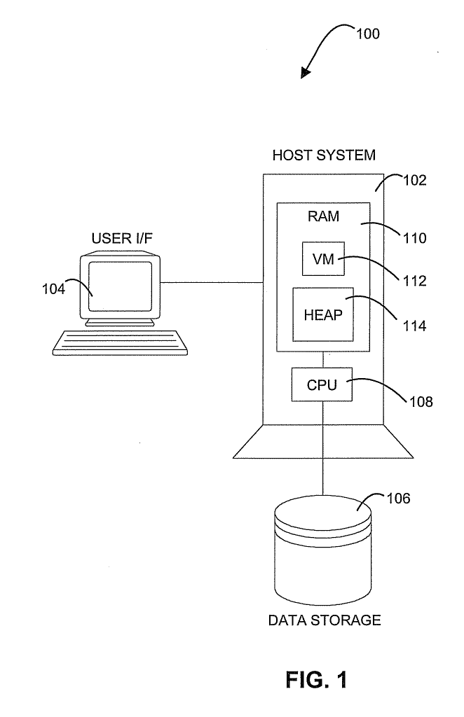

Turning now to the drawings, it will be seen that in FIG. 1 there is a block diagram of a system 100 for optimizing virtual machine memory consumption that is implemented in accordance with exemplary embodiments. The system 100 of FIG. 1 includes a host system 102 in communication with a user interface 104 and a data storage device 106. The host system 102 may be any type of computer system known in the art. For example, the host system 102 can be a desktop computer, a laptop computer, a general-purpose computer, a mainframe computer, or an embedded computer (e.g., a computer within a wireless device). In exemplary embodiments, the host system 102 executes computer readable program code. While only a single host system 102 is shown in FIG. 1, it will be understood that multiple host systems can be implemented, each in communication with one another via direct coupling or via one or more networks. For example, multiple host systems 102 may be interconnected through a distributed network architecture. The single host system 102 may also represent a server in a client-server architecture.

In exemplary embodiments, the host system 102 includes at least one processing circuit (e.g., CPU 108) and volatile memory (e.g., RAM 110). The CPU 108 may be any processing circuit technology known in the art, including for example, a microprocessor, a microcontroller, an application specific integrated circuit (ASIC), a programmable logic device (PLD), a digital signal processor (DSP), or a multi-core/chip module (MCM). The RAM 110 represents any volatile memory or register technology that does not retain its contents through a power/depower cycle, which can be used for holding dynamically loaded application programs and data structures. The RAM 110 may comprise multiple memory banks partitioned for different purposes, such as data cache, program instruction cache, and temporary storage for various data structures and executable instructions. It will be understood that the host system 102 also includes other computer system resources known in the art, and not depicted, such as one of more power supplies, clocks, interfacing circuitry, communication links, and peripheral components or subsystems.

The user interface 104 includes a combination of input and output devices for interfacing with the host system 102. For example, user interface 104 inputs can include a keyboard, a keypad, a touch sensitive screen for inputting alphanumerical information, or any other device capable of producing input to the host system 102. Similarly, the user interface 104 outputs can include a monitor, a terminal, a liquid crystal display (LCD), or any other device capable of displaying output from the host system 102.

The data storage device 106 refers to any type of storage and may comprise a secondary storage element, e.g., hard disk drive, tape, or a storage subsystem that is internal or external to the host system 102. In alternate exemplary embodiments, the data storage device 106 includes one or more solid-state devices, such as ROM, PROM, EPROM, EEPROM, flash memory, NOVRAM or any other electric, magnetic, optical or combination memory device capable of storing data (i.e., a storage medium), some of which represent executable instructions for the CPU 108. It will be understood that the data storage device 106 shown in FIG. 1 is provided for purposes of simplification and ease of explanation and is not to be construed as limiting in scope. To the contrary, there may be multiple data storage devices 106 utilized by the host system 102.

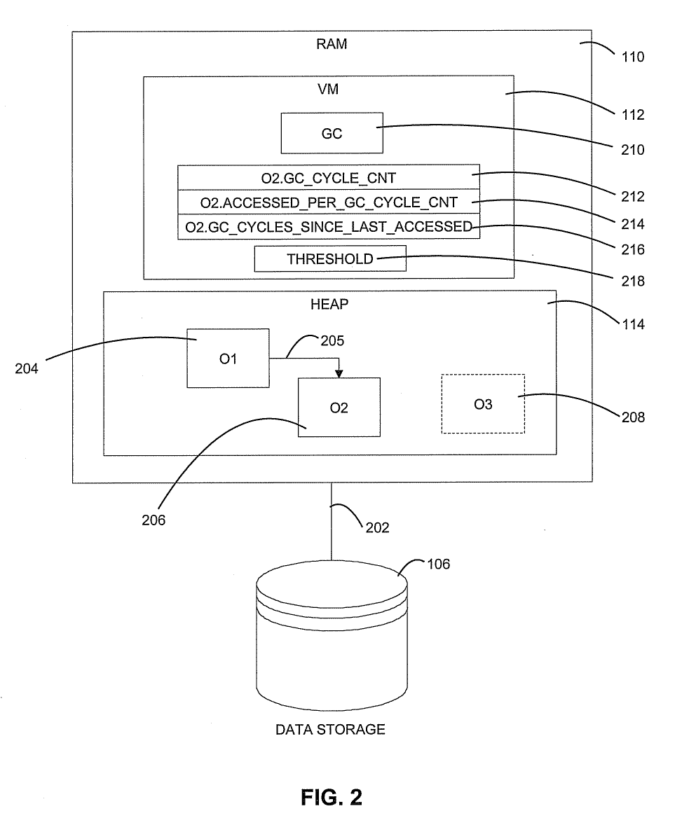

In exemplary embodiments, the host system 102 executes a virtual machine (VM) 112 that serves as an interface between applications executed on the host system 102 and lower level hardware and/or operating system interfaces of the host system 102. For example, the VM 112 may be a Java™ virtual machine (JVM™) that processes bytecode for execution by the CPU 108 of the host system 102. In exemplary embodiments, the VM 112 manages a heap 114 resident in the RAM 110. The heap 114 represents a portion of memory allocated for use during program execution (i.e., runtime) for various data structures, such as objects. In exemplary embodiments, the VM 112 controls allocation and sizing constraints of the heap 114, as well as the addition and removal of objects to/from the heap 114. Further details of optimizing the VM 112 memory consumption for objects in the heap 114 are provided in reference to FIGS. 2-5.

Turning now to FIG. 2, the memory system components from the system 100 of FIG. 1 are depicted as the RAM 110 in communication with the data storage device 106 via a communication link 202. The communication link 202 represents a logical connection that may be achieved via the CPU 108 of the host system 102 as a data transfer path between the RAM 110 and the data storage device 106. The RAM 110 includes the VM 112 and the heap 114 of FIG. 1, with additional exemplary details depicted therein. For example, the heap 114 may include an object O1 204 with a reference 205 to a second object O2 206. The heap 114 may also include a garbage object O3 208 that is not referenced by either the object O1 204 or the object O2 206. In general, a garbage object is an object that is not referenced by other objects, and therefore, it can be removed to free up memory space. The heap 114 may further include numerous other objects with varying relationships (not depicted). In exemplary embodiments, the VM 112 includes a garbage collector (GC) 210 that monitors the heap 114 for garbage objects, such as the garbage object O3 208, and periodically removes the garbage objects. While the GC 210 can identify and remove the garbage object O3 208, the GC 210 may not remove object O2 206 as garbage, since object O1 204 references object O2 206. As the GC 210 monitors the heap 114 for garbage, the GC 210 can track garbage collection metrics on either a per garbage collection cycle basis or a per object basis. For example, the GC 210 may track information about object O2 206, such as how many GC cycles have elapsed since object O2 206 was added to the heap 114, as variable O2.GC_CYCLE_CNT 212.

Using information generated by the GC 210, the VM 112 may perform additional analysis beyond garbage collection, to look for dead objects that can be deflated to reduce the total memory consumption of the heap 114. In exemplary embodiments, the VM 112 counts the number of accesses per garbage collection cycle for each object to determine if each object is used infrequently. For example, the VM 112 may employ a variable, O2.ACCESSED_PER_GC_CYCLE_CNT 214, to count the number of times that the VM 112 accesses object O2 206 in the heap 114 between garbage collection cycles. If no VM 112 accesses occur to object O2 206 between garbage collection cycles, then the monitored object O2 206 is a candidate to be removed from the heap 114 to optimize heap memory space. In order to identify object O2 206 as a dead object, a second variable can be employed to determine that object O2 206 has not been accessed for a sufficient duration. A variable O2.GC_CYCLES_SINCE_LAST_ACCESSED 216 may be triggered to count the number of garbage collection cycles occurring since the VM 112 last accessed object O2 206. In exemplary embodiments, the duration of no access to object O2 206 is deemed long enough to identify object O2 206 as a dead object when the garbage collection cycles since last access counter (e.g., O2.GC_CYCLES_SINCE_LAST_ACCESSED 216) crosses a threshold value (THRESHOLD 218). The THRESHOLD 218 may be user configurable in the VM 112. Once an object is identified as a dead object, the dead object can be “deflated”. While the foregoing description focused on a single dead object, it will be understood that any number of dead objects within the heap 114 can be handled in like manner.

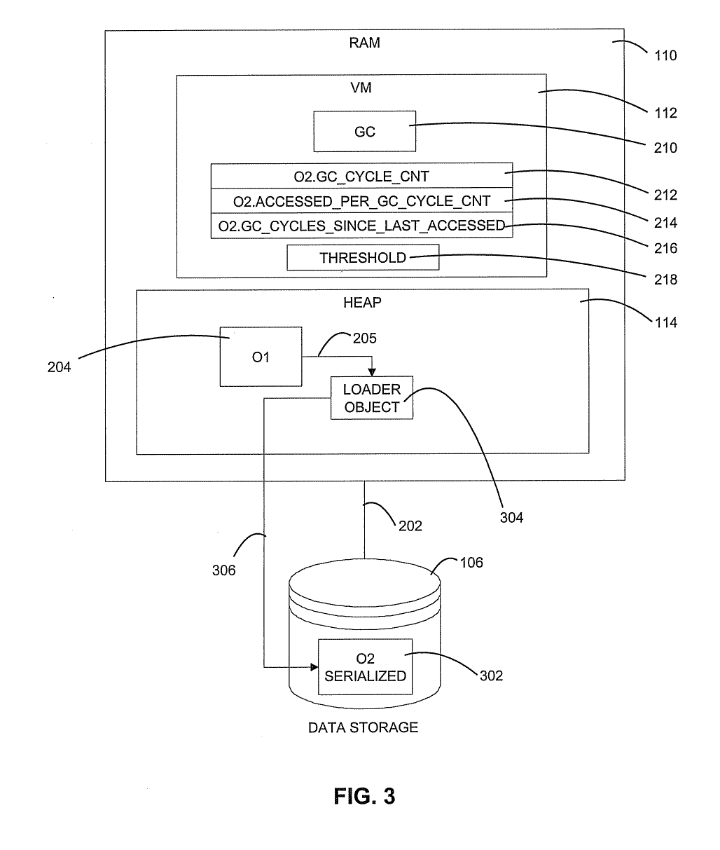

In exemplary embodiments, the process of deflating a dead object includes copying the dead object to the data storage device 106 as a serialized object, and replacing the dead object in the heap 114 with a loader object. For example, assuming that object O2 206 is identified as a dead object, object O2 206 then is copied to the data storage device 106 as serialized object O2 302, as depicted in FIG. 3. A loader object 304 of FIG. 3 replaces the dead object O2 206 in the heap 114. In exemplary embodiments, the loader object 304 is smaller than the dead object O2 206, thus the amount of memory consumed in the heap 114 is reduced when the loader object 304 replaces the dead object O2 206. The loader object 304 includes a reference 306 to the serialized object O2 302 so that the dead object O2 206 may later be restored if needed. Placing the loader object 304 at the same location in the heap 114 that the dead object O2 206 formerly occupied may make the change transparent to any objects that had previously referenced the dead object O2 206, such as object O1 204 via reference 205. Thus, it may appear as if the dead object O2 206 has been deflated, because its size is reduced, but it has not been entirely eliminated as garbage. Object deflation may be performed during a garbage collection cycle as part of the overall optimization of the heap 114 memory space. For example, after a garbage collection cycle, not only have garbage objects, such as the garbage object O3 of FIG. 2 been removed, but dead objects, such as the dead object O2 206 may be deflated (i.e., replaced in the heap 114 with the smaller loader object 304), thus freeing up additional memory. Since garbage collection cycles may be triggered based on an amount of space consumed in the heap 114, a further reduction in space consumed can equate to a longer period of time between garbage collection cycles, leaving more time available for runtime applications.

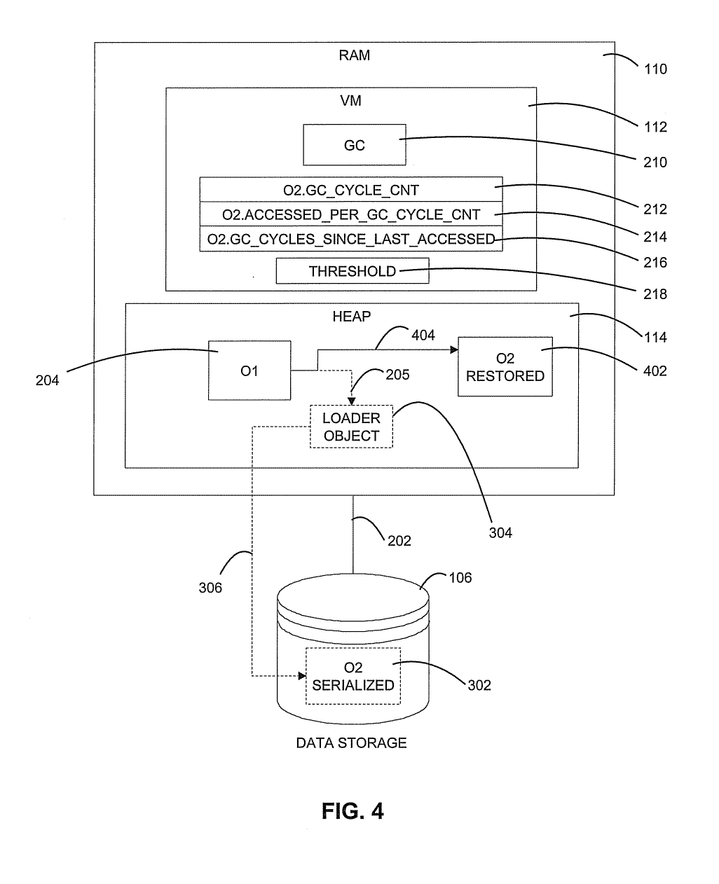

In exemplary embodiments, when an object referencing a loader object attempts to traverse a reference to access a dead object, the loader object reloads the dead object such that it can be accessed. For example, if object O1 204 attempts to traverse the reference 205 to access object O2 206, the attempted traversal will instead access the loader object 304. In response thereto, the loader object 304 traverses the reference 306 to locate the serialized object O2 302. As depicted in FIG. 4, the loader object 304 copies the serialized object O2 302 to the heap 114 as restored object O2 402. Restoration is also referred to as “inflation”, since the amount of memory previously associated with the object increases from a smaller amount to a larger amount (e.g., loader object 304 to restored object O2 402). The restored object O2 402 may be written to a location in the heap 114 where there is sufficient contiguous memory for the restored object O2 402 to fit. Once the restored object O2 402 is written to the heap 114, the reference 205 may be rewired as a new reference 404 between the object O1 204 and the restored object O2 402. Since the loader object 304 and the serialized object O2 302 are no longer useful, they may be deleted to free up space in the heap 114 and the data storage device 106 respectively.

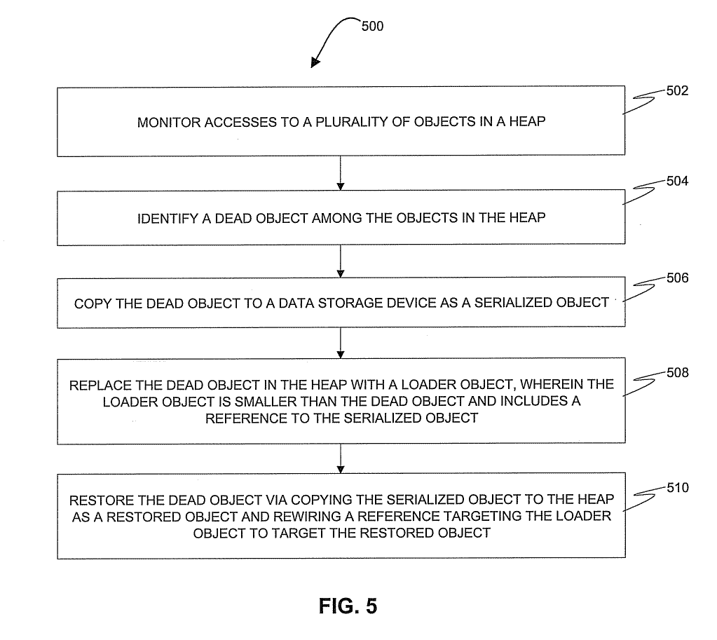

Turning now to FIG. 5, a process 500 for optimizing VM memory consumption will now be described in accordance with exemplary embodiments, and in reference to FIGS. 1-4. At block 502, the VM 112 monitors accesses to a plurality of objects in the heap 114. The monitoring may include counting the number of times that the VM 112 accesses each of the objects in the heap 114 between garbage collection cycles of the GC 210. In exemplary embodiments, the VM 112 triggers a garbage collection cycles since last access counter (e.g., O2.GC_CYCLES_SINCE_LAST_ACCESSED 216) to count when no VM 112 accesses occur to a monitored object, such as the object O2 206, between garbage collection cycles.

At block 504, the VM 112 identifies a dead object O2 206 among the objects in the heap 114. Identifying the dead object O2 206 may include using the garbage collection cycles since last access counter (e.g., O2.GC_CYCLES_SINCE_LAST_ACCESSED 216) to count the number of garbage collection cycles occurring since the monitored object was last accessed, once the counter is triggered. The monitored object may be identified as the dead object O2 206 when the garbage collection cycles since last access counter (e.g., O2.GC_CYCLES_SINCE_LAST_ACCESSED 216) crosses a threshold value (e.g., THRESHOLD 218).

At block 506, the VM 112 copies the dead object O2 206 to the data storage device 106 as a serialized object O2 302. At block 508, the VM 112 replaces the dead object O2 206 in the heap 114 with a loader object 304, thus deflating the dead object O2 206. In exemplary embodiments, the loader object 304 is smaller than the dead object O2 206, and the loader object 304 includes a reference 306 to the serialized object O2 302.

At block 510, the VM 112 restores (inflates) the dead object O2 206 via copying the serialized object O2 302 to the heap 114 as the restored object O2 402. The VM 112 can determining the size of the serialized object O2 302, locate contiguous space within the heap 114 that is greater than or equal to the size of the serialized object O2 302, and perform the copying of the serialized object O2 302 to the located contiguous space within the heap 114 as the restored object O2 402. The VM 112 further rewires any references targeting the loader object 304 to target the restored object O2 402, e.g., reference 205 to reference 404. The VM 112 may also remove the loader object 304 from the heap 114. In alternate exemplary embodiments, the loader object 304 is abandoned as garbage, and the GC 210 removes it. In exemplary embodiments, object restoration is performed when an object referencing the loader object 304, such as object O1 204 traverses the reference 205 to the loader object 304. Additionally, the VM 112 may remove the serialized object O2 302 from the data storage device 106.

While the exemplary embodiments as previously described refer to a virtual machine (e.g., VM 112), it will be understood that the inventive principles may be applied to any hardware and/or software component that provides equivalent or near equivalent functionality. For example, the VM 112 can include any software component that performs garbage collection or is capable of managing the addition and removal of objects to a dynamic storage structure, such as the heap 114.

Technical effects of exemplary embodiments include reducing the effective size of objects in a heap that are infrequently used but are still referenced (i.e., dead objects), through copying the dead objects to an alternate storage location and replacing the dead objects in the heap with loader objects. Since garbage collection is typically triggered when an allocated amount of space in the heap is exceeded, increasing the amount of free space in the heap can reduce the frequency of garbage collection. Replacing dead objects in the heap with loader objects may also decrease heap fragmentation, because dead objects often vary in size, while loader objects can be about the same size. Advantages of exemplary embodiments may include reducing the garbage collection frequency, thereby freeing processing resources. Decreasing heap fragmentation can also save space in the heap through freeing larger contiguous memory blocks.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, universal serial bus (USB) flash drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for optimizing virtual machine (VM) memory consumption, comprising:
monitoring VM accesses to a plurality of objects in a heap;
identifying a dead object among the objects in the heap;
copying the dead object to a data storage device as a serialized object; and
replacing the dead object in the heap with a loader object, wherein the loader object is smaller than the dead object and includes a reference to the serialized object.

2. The method of claim 1 further comprising:
restoring the dead object to the heap, wherein restoring includes:
copying the serialized object to the heap as a restored object;
rewiring a reference targeting the loader object to target the restored object; and
removing the loader object from the heap.

3. The method of claim 2 wherein the restoring is performed when an object referencing the loader object traverses the reference to the loader object.

4. The method of claim 2 further comprising:
removing the serialized object from the data storage device.

5. The method of claim 2 wherein copying the serialized object to the heap as a restored object further comprises:
determining a size of the serialized object;
locating contiguous space within the heap that is greater than or equal to the size of the serialized object; and
copying the serialized object to the located contiguous space within the heap as the restored object.

6. The method of claim 1 wherein monitoring VM accesses to the objects in the heap further comprises:
counting a number of times that the VM accesses each of the objects in the heap between garbage collection cycles; and
triggering a garbage collection cycles since last access counter to count when no VM accesses occur to a monitored object between garbage collection cycles.

7. The method of claim 6 wherein identifying the dead object further comprises:
counting a number of garbage collection cycles occurring since the monitored object was last accessed by the VM when the garbage collection cycles since last access counter is triggered to count; and
identifying the monitored object as the dead object when the garbage collection cycles since last access counter crosses a threshold value.

8. A system for optimizing virtual machine (VM) memory consumption, comprising:
a data storage device; and
a host system in communication with the data storage device, the host system executing a VM, the VM performing:
monitoring accesses to a plurality of objects in a heap;
identifying a dead object among the objects in the heap;
copying the dead object to the data storage device as a serialized object; and
replacing the dead object in the heap with a loader object, wherein the loader object is smaller than the dead object and includes a reference to the serialized object.

9. The system of claim 8 wherein the VM further performs:
restoring the dead object to the heap, wherein restoring includes:
copying the serialized object to the heap as a restored object;
rewiring a reference targeting the loader object to target the restored object; and
removing the loader object from the heap.

10. The system of claim 9 wherein the restoring is performed when an object referencing the loader object traverses the reference to the loader object.

11. The system of claim 9 wherein the VM further performs:
removing the serialized object from the data storage device.

12. The system of claim 9 wherein copying the serialized object to the heap as a restored object further comprises:
determining a size of the serialized object;
locating contiguous space within the heap that is greater than or equal to the size of the serialized object; and
copying the serialized object to the located contiguous space within the heap as the restored object.

13. The system of claim 8 wherein monitoring accesses to the objects in the heap further comprises:
counting a number of times that each of the objects in the heap is accessed between garbage collection cycles; and
triggering a garbage collection cycles since last access counter to count when no accesses occur to a monitored object between garbage collection cycles.

14. The system of claim 13 wherein identifying the dead object further comprises:
counting a number of garbage collection cycles occurring since the monitored object was last accessed when the garbage collection cycles since last access counter is triggered to count; and
identifying the monitored object as the dead object when the garbage collection cycles since last access counter crosses a threshold value.

15. A computer program product for optimizing virtual machine (VM) memory consumption, the computer program product comprising:
a storage medium readable by a processing circuit and storing instructions for execution by the processing circuit for implementing a method, the method comprising:
monitoring VM accesses to a plurality of objects in a heap;
identifying a dead object among the objects in the heap;
copying the dead object to a data storage device as a serialized object; and
replacing the dead object in the heap with a loader object, wherein the loader object is smaller than the dead object and includes a reference to the serialized object.

16. The computer program product of claim 15 further comprising:
restoring the dead object to the heap, wherein restoring includes:
copying the serialized object to the heap as a restored object;
rewiring a reference targeting the loader object to target the restored object; and
removing the loader object from the heap.

17. The computer program product of claim 16 wherein the restoring is performed when an object referencing the loader object traverses the reference to the loader object.

18. The computer program product of claim 16 wherein copying the serialized object to the heap as a restored object further comprises:
determining a size of the serialized object;
locating contiguous space within the heap that is greater than or equal to the size of the serialized object; and
copying the serialized object to the located contiguous space within the heap as the restored object.

19. The computer program product of claim 15 wherein monitoring VM accesses to the objects in the heap further comprises:
counting a number of times that the VM accesses each of the objects in the heap between garbage collection cycles; and
triggering a garbage collection cycles since last access counter to count when no VM accesses occur to a monitored object between garbage collection cycles.

20. The computer program product of claim 19 wherein identifying the dead object further comprises:
counting a number of garbage collection cycles occurring since the monitored object was last accessed by the VM when the garbage collection cycles since last access counter is triggered to count; and
identifying the monitored object as the dead object when the garbage collection cycles since last access counter crosses a threshold value.
